(19) United States
(12) Patent Application Publication
(10) Pub. No.: US 2026/0223265 A1
(43) Pub. Date: Jul. 30, 2026

(54) POWER DEMULTIPLEXER FOR HIGH EFFICIENCY MULTI-CHANNEL LED DRIVER

(71) Applicant: SIGNIFY HOLDING B.V., EINDHOVEN (NL)

(72) Inventors: KARNEKUMAR ARULANDU, BREDA (NL); HAIMIN TAO, EINDHOVEN (NL)

(21) Appl. No.: 19/149,117

(22) PCT Filed: Jan. 11, 2024
(86) PCT No.: PCT/EP2024/050596

§ 371 Date: Jul. 18, 2025

(30) Foreign Application Priority Data
Jan. 19, 2023 (EP) 23152342.4

(51) Int. Cl. H05B 45/385

(52) U.S. Cl. CPC H05B 45/385

(57) ABSTRACT

The invention relates to a power stage for powering a first load, the first load being couplable between a first output and a second output, the power stage comprising a first input for receiving a bus voltage, the first output coupled to the first input and arranged to be couplable to the first load, a first capacitor coupled between the second output and a first further node and couplable in series with the first load, a secondary power converter comprising a controller for controlling the secondary power converter, a first inductive element and a first switching element coupled in series between a second input and a return node, a second inductive element, inductively coupled to the first inductive element, and a first unidirectional device coupled in series between the second output and the first further node, wherein the secondary power converter is arranged to provide a current to the first capacitor that is of a reverse polarity of a current provided to the first capacitor via the first load.

### FIELD OF THE INVENTION

The invention relates to a power stage for powering a load. The invention further relates to a powering system.

### BACKGROUND OF THE INVENTION

A power stage, also referred to as a driver, is often used regulate the power that is provided to a load. The load may require a specific voltage for it to operate properly. If the load or driver is replaced, the load or driver may be broken or upgraded, the load and driver may not match in provided and required voltages anymore. If the driver voltage is larger than the voltage required by the load, the voltage difference may result in additional losses. If the driver voltage is lower than the voltage required by the load, the load may not even start up or function properly.

Especially in the field of lighting, the lighting load may be independently replaced from its driver. It may occur that upon replacing a lighting load and a new combination of a driver and lighting load is formed, the forward voltage of the lighting load may not exactly match the voltage provided by the driver. This may result in additional power losses in the driver or a non-functioning combination of driver and lighting load. It is desired that a larger design freedom can be provided by allowing a wider range of drivers to be combined with more type of lighting loads.

### SUMMARY OF THE INVENTION

It is an objective of the invention to provide a power efficient device that allows a provided voltage from e.g. a driver, to match with a required voltage of a load.

To achieve this effect, in a first aspect of the invention a power stage for powering a first load, the first load being couplable between a first output and a second output, is provided. The power stage comprises:
a first input for receiving a bus voltage;
the first output coupled to the first input and arranged to be couplable to the first load;
a first capacitor coupled between the second output and a first further node and couplable in series with the first load;
a secondary power converter comprising:
a controller for controlling the secondary power converter;
a first inductive element and a first switching element coupled in series between a second input and a return node;
a second inductive element, inductively coupled to the first inductive element, and a first unidirectional device coupled in series between the second output and the first further node,
wherein the secondary power converter is arranged to provide a current to the capacitor that is of a reverse polarity of a current provided to the first capacitor via the first load.

The power stage according to the invention has a first input that can receive a bus voltage. A bus voltage can be any kind of voltage that is preferably a stable voltage. This voltage may have a ripple such that the bus voltage is an average stable voltage. A first output is provided to which a first load may be connected. The first output is also coupled to the first input.

A first capacitor is provided between the second output, to which the first load can also be coupled, and a first further node. When the first load is coupled between the first output and the second output, the first load and the first capacitor are in series. A secondary power converter is provided. The second power converter has a controller that is used to control the second power converter. A first inductive element and a first switching element are coupled in series with each other and between a second input and a return node. The first inductive element is inductively coupled to a second inductive element. A first unidirectional device is coupled in series between the second output and the first further node.

The secondary power converter is arranged to provide a current to the first capacitor that is of a reverse polarity of a current provided to the capacitor via the first load.

The power stage according to the invention allows the voltage of the first load to be matched with the bus voltage. In this example, the sum of the voltage over the first load and the first capacitor is equal to the bus voltage. The voltage over the first load is not easy to regulate but the voltage over the first capacitor can be regulated by the secondary power converter. The secondary power converter uses the first switching element to allow a current to flow through the first inductive element. The inductive coupling between the first inductive element and the second inductive element effectively causes the first inductive element and the second inductive element to form a flyback transformer. The current flowing through the first inductive element is therefore reflected to the second inductive element. The first unidirectional device is coupled to the second inductive element such that when the first switching element is closed, no current flows through the second inductive element. Instead, when the first switching element is opened, the current through the first inductive element is reflected to the secondary inductive element such that this current is used to provide a current to the first capacitor of reverse polarity as the current that flows through the first load. For example, the current flowing through the first load also flows through the first capacitor. This may be a current that discharges the first capacitor. The current provided via the second inductive element to the capacitor is of the polarity such that it charges the first capacitor. The balance between the charging and the discharging of the capacitor allows the voltage over the first capacitor to be regulated, and therefore also the current flowing through the first load. The duration of the on time of the first switching element can be used to provide a regulated amount of energy to the first capacitor.

In a further example, the second input is directly coupled to the first input.

It is preferred to provide a direct coupling between the second input and the first input so that energy losses can be kept as low as possible. However, if needed, electric components can be placed between the second input and the first input to e.g. provide additional functionality.

In a further example, the first further node is coupled to the return node.

Preferably, both the first capacitor and the series combination of the first inductive element and the first switching element are directly coupled to the return node. This allows a simple and energy efficient design of the power stage.

In a further example, the power stage comprises a linear current regulator in series between the first further node and the return node.

A linear current regulator can be provided between the further node and the return node. The linear current regulator may then effectively be connected in series with the first load and the first capacitor. The linear current regulator may be used to further reduce a current ripple of the current through the first load.

In a further example, the current provided via the first load is arranged for discharging the first capacitor.

In another example, the current provided via the first load is arranged for charging the first capacitor.

In a further example, the current provided via the second inductive element is arranged for charging the first capacitor.

In another example, the current provided via the second inductive element is arranged for discharging the first capacitor.

In a further example, the secondary power converter is a flyback converter.

Using a flyback converter for the secondary power converter allows an easy design for the inductive coupling between the first inductive element and the second inductive element to be realized.

In another example, a powering system is provided. The powering system comprises:
a power stage according to any of the preceding examples;
a third output coupled to the first input and arranged to be couplable to a second load, the second load being couplable between the third output and a fourth output;
a second capacitor coupled between the fourth output and a second further node and couplable in series with the second load;
a tertiary power converter comprising:
a third inductive element, inductively coupled to the first inductive element, a third switching element and a second unidirectional device coupled in series between the fourth output and the second further node,
wherein the secondary power converter further comprises a second switching element in series with the first unidirectional device,
wherein the tertiary power converter is arranged to provide a current to the second capacitor that is of a reverse polarity of a current provided to the second capacitor via the second load.

An additional second, independent, load may be powered by the same powering system. The second load may be coupled in series with a second capacitor. A tertiary power supply may receive power from the first inductive element. The tertiary power supply has a third inductive element, inductively coupled to the first inductive element, a third switching element and a second unidirectional device coupled in series between the fourth output and the second further node. The tertiary power supply may operate the same way as the secondary power supply. The second unidirectional device allows current to be provided by the third inductive element to the second capacitor when the first switching element is open. In addition, the tertiary power converter is arranged to provide a current to the second capacitor that is of a reverse polarity of a current provided to the capacitor via the second load. This means that when the current provided via the load charges the capacitor, the current provided by the third inductive element discharges the capacitor and vice versa. The primary inductive element provides a current to the second inductive element and the third inductive element. To determine the power distribution between the second inductive element and the third inductive element, the secondary power converter has a second switching element in series with the first unidirectional device and the tertiary power converter has a third switching element in series with the second unidirectional device. The control of the second switch and the third switch allows a regulated current to flow to the first capacitor and the second capacitor respectively.

In another example, first load and the second load are comprised in the powering system.

In another example, the first load and/or the second load is/are a lighting load.

Preferably, at least one load is a lighting load. The other load may also be a lighting load but can also be another type of load such as a sensor.

In another example, the lighting load is a semiconductor lighting load.

Examples of semiconductor lighting loads may be LEDs or lasers such as laser diodes or Vertical-cavity surface-emitting laser, VCSEL.

In a further example, a forward voltage of the first load is different from the forward voltage of the second load.

The powering system according to the examples allows a difference between forward voltages of the loads to be compensated by providing different voltages across the first capacitor and the second capacitor.

In a further example, the powering system further comprises a mains power converter adapted to convert a mains input voltage into the bus voltage.

The bus voltage can be an unregulated voltage but preferably, the bus voltage is a regulated voltage. The mains power converter may regulate an unregulated voltage, such as a rectified mains voltage, into a regulated bus voltage.

### BRIEF DESCRIPTION OF THE DRAWINGS

Examples of the invention will now be described with reference to the accompanying drawings, in which:

FIG. 1 shows an example of a circuit diagram of a power stage.

FIG. 2 shows another example of a circuit diagram of a power stage.

FIG. 3 shows another example of a circuit diagram of a powering system.

FIG. 4 shows another example of a circuit diagram of a powering system.

FIG. 5 shows an example of a powering system.

FIG. 6 shows another example of a powering system.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should also be understood that the Figures are merely schematic and are not drawn to scale. It should also be understood that the same reference numerals are used throughout the Figures to indicate the same or similar parts.

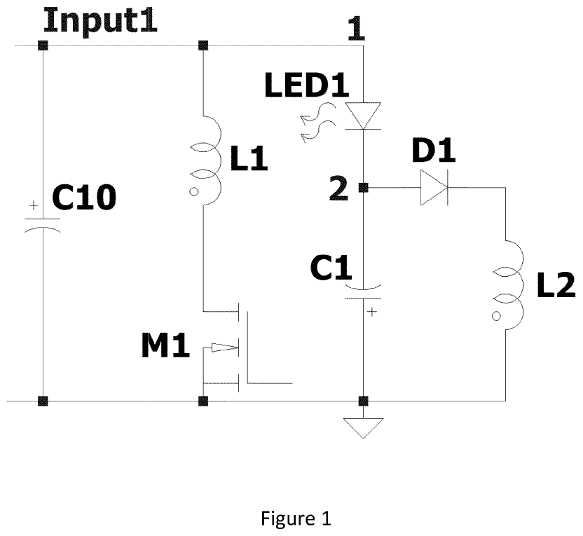

FIG. 1 shows an example of a power stage. The power stage has a first input, Input that is arranged to receive a bus voltage. The power stage also has a ground node for providing a return path for the current provided via the input, Input. This node is shown as the ground. In this example, it may also be referred to as the return node or first further node. A first inductive element L1 and a first switching element M1 are coupled in series between a second input Input2, which is in this example directly coupled to the first input Input1, and the return node.

A first load LED1 and a first capacitor C1 are coupled in series between the first input, Input and a first further node, which is in this example directly coupled to the return node. The first load LED1 may form part of the power stage. The power stage has therefore a first output 1 and a second output 2 to which the first load LED1 is coupled. In this example, the first output 1 is directly coupled to first input Input1. The second output 2 is in this example directly coupled to the first capacitor C1 and the anode of the first unidirectional device D1. The unidirectional device D1 and the second inductive element L2 are coupled in series between the second output 2 and the first further node. In this example, the secondary power converter comprises the first inductive element L1, the first switching element M1, the first unidirectional device D1 and the second inductive element L2. The first inductive element L1 and the second inductive element L2 are inductively coupled such that the secondary power converter forms a flyback converter. The secondary power converter may be controlled by a controller. The first capacitor C1 is considered to be the load for the secondary power converter. The secondary power converter provides a current to the first capacitor C1 in the positive direction of the polarity of the first capacitor C1. The current flowing through the first load LED1 flows through the first capacitor C1 into the negative direction of the polarity of the first capacitor C1. The insight of the invention is that the voltage of the first load LED1 needs to be matched with the bus voltage so that a current through the first load LED1 can also be regulated. In this example, the bus voltage is lower than the voltage required by the first load LED1. The voltage over the first capacitor has a negative polarity compared to the voltage over the first load LED1, effectively ‘increasing’ the bus voltage with respect to the required load voltage. The secondary power converter is therefore used to increase the bus voltage level such that the voltage across the first load LED1 is sufficiently large for a regulated desired current amplitude to flow through the first load LED1.

As an example, the bus voltage may be 20 V and the required voltage for the first load LED1 may be 25 V.

The bus voltage is equal to the sum of the first load LED1 voltage and the first capacitor C1 voltage. The secondary power converter is then controlled to generate a voltage over the first capacitor of −5 V, resulting in V_{bus}=V_{load}+V_{c}, resulting in 20 V=25 V-5V.

To provide a more stable bus voltage, this bus voltage can be buffered by a buffer capacitor C10. The bus voltage may have substantially large double-line-frequency voltage ripple since the secondary power converter will compensate for the ripple and keep the load voltage constant.

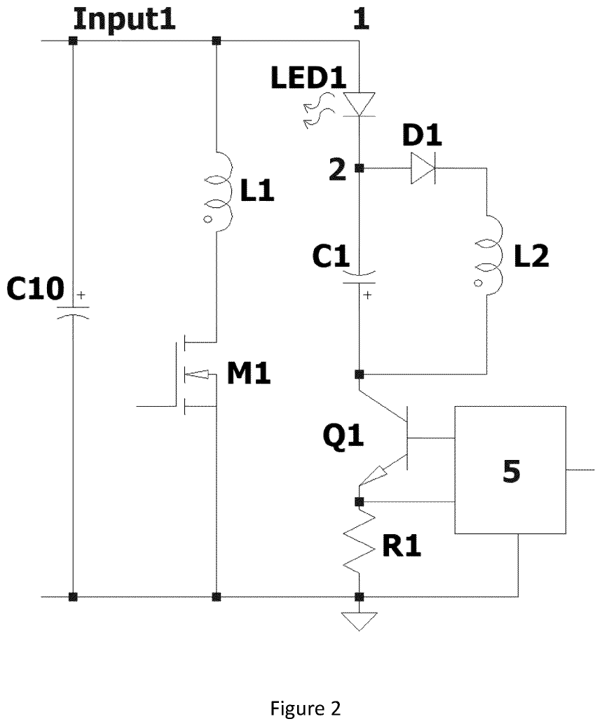

FIG. 2 shows an improved example of the power stage as shown in FIG. 1. The power stage has a first input Input1 that is arranged to receive a bus voltage. The power stage also has a ground node for providing a return path for the current provided via the input Input. This node is shown as the ground. In this example, it may also be referred to as the return node. A first inductive element L1 and a first switching element M1 are coupled in series between a second input Input2, which is in this example directly coupled to the first input Input1, and the return node. A first load LED1 and a first capacitor C1 are coupled in series between the first input Input1 and a first further node. The first load LED1 may form part of the power stage. The power stage has therefore a first output 1 and a second output 2 to which the first load LED1 is coupled. In this example, the first output 1 is directly coupled to first input Input1. The second output 2 is in this example directly coupled to the first capacitor C1 and the anode of the first unidirectional device D1. The unidirectional device D1 and the second inductive element L2 are coupled in series between the second output 2 and the first further node. In this example, the secondary power converter comprises the first inductive element L1, the first switching element M1, the first unidirectional device D1 and the second inductive element L2. The first inductive element L1 and the second inductive element L2 are inductively coupled such that the secondary power converter forms a flyback converter. The secondary power converter may be controlled by a controller. The first capacitor C1 is considered to be the load for the secondary power converter. The secondary power converter provides a current to the first capacitor C1 in the positive direction of the polarity of the first capacitor C1. The current flowing through the first load LED1 flows through the first capacitor C1 into the negative direction of the polarity of the first capacitor C1. The insight of the invention is that the voltage of the first load LED1 needs to be matched with the bus voltage so that a current through the first load LED1 can also be regulated. In this example, the bus voltage is lower than the voltage required by the first load LED1. The voltage over the first capacitor has a negative polarity compared to the voltage over the first load LED1, effectively ‘increasing’ the bus voltage with respect to the required load voltage. The secondary power converter is therefore used to increase the bus voltage level such that the voltage across the first load LED1 is sufficient large for a regulated desired current amplitude to flow through the first load LED1.

As an example, the bus voltage may be 20 V and the required voltage for the first load LED1 may be 25 V.

The bus voltage is equal to the sum of the first load LED1 voltage and the first capacitor C1 voltage. The secondary power converter is then controlled to generate a voltage over the first capacitor of −5 V, resulting in V_{bus}=V_{load}+V_{c}, resulting in 20 V=25 V-5V.

To provide a more stable bus voltage, this bus voltage can be buffered by a buffer capacitor C10. An additional circuit is provided to reduce a ripple of a current that flows through the first load LED1. This is a linear current regulator. A transistor Q1 with a current sense circuit R1 may be provided in series between the first further node and the return node. A feedback circuit 5 may receive a signal from the current sense circuit R1 representing the current flowing through the transistor Q1. In this example, the current sense circuit R1 is a resistor. The feedback circuit 5 uses the signal to control the base of the transistor Q1 such that a desired current flows through the transistor Q1. The feedback circuit may also receive an additional signal for setting the desired current amplitude. This may be a dimming signal such as a PWM dimming signal that may be provided by a controller that is controlled by an external device, such as a remote controller.

It is to be noted that the linear current regulator can be implemented in any of the examples provided and not only in the example of FIG. 2. Each capacitor in series with a corresponding load can also be coupled in series with a corresponding linear current regulator. In such case, the further nodes are not directly coupled to the return node since the linear current regulator is placed in between.

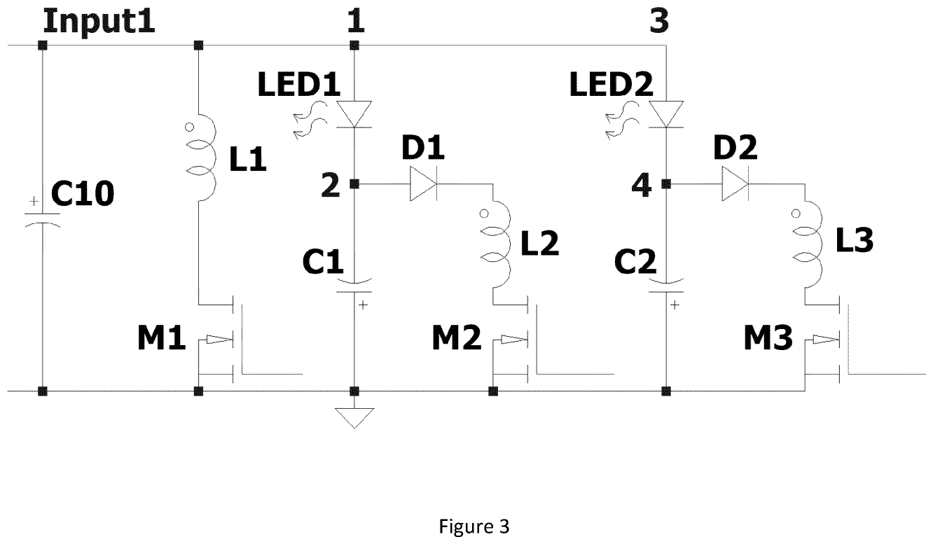

FIG. 3 shows an example of a powering system. The powering system may have a power stage according to the examples of the invention. The powering system has a first input Input1 that is arranged to receive a bus voltage. The powering system also has a ground node for providing a return path for the current provided via the input Input. This node is shown as the ground. In this example, it may also be referred to as the return node or first further node. A first inductive element L1 and a first switching element M1 are coupled in series between a second input Input2, which is in this example directly coupled to the first input Input1, and the return node. A first load LED1 and a first capacitor C1 are coupled in series between the first input Input1 and a first further node, which is in this example directly coupled to the return node. The first load LED1 may form part of the powering system. The powering system has therefore a first output 1 and a second output 2 to which the first load LED1 is coupled. In this example, the first output 1 is directly coupled to first input Input1. The second output 2 is in this example directly coupled to the first capacitor C1 and the anode of the first unidirectional device D1. The first unidirectional device D1, a second switching element M2 and the second inductive element L2 are coupled in series between the second output 2 and the first further node. In this example, the secondary power converter comprises the first inductive element L1, the first switching element M1, the first unidirectional device D1, the second switching element M2 and the second inductive element L2.

A second load LED2 and a second capacitor C2 are coupled in series between the first input Input1 and a second further node, which is in this example directly coupled to the return node. The second load LED1 may form part of the powering system. The powering system has therefore a third output 3 and a fourth output 4 to which the second load LED2 is coupled. In this example, the third output 3 is directly coupled to first input Input1. The fourth output 4 is in this example directly coupled to the second capacitor C2 and the anode of the second unidirectional device D2. The second unidirectional device D2, a third switching element M3 and the third inductive element L3 are coupled in series between the fourth output 4 and the second further node. In this example, the tertiary power converter comprises the second unidirectional device D2, the third switching element M3 and the third inductive element L3. The controller may also be used to control the tertiary power converter. This means that the controller may for example be used to control the third switching element M3. The first inductive element L1, the second inductive element L2 and the third inductive element are inductively coupled such that the secondary power converter forms a flyback converter. A major difference with a regular flyback converter is that at the secondary side and the tertiary side i.e., at the side of the second inductive element L2 and the third inductive element L3, a switching element is placed to allow or prevent a current to flow to a corresponding first capacitor C1 or second capacitor C2. The current through the first inductive element L1 is reflected to the second inductive element L2 and the third inductive element L3. The second switching element M2 and the third switching element M3 can be controlled to control the currents flowing to the first capacitor C1 and the second capacitor C2 from the second inductive element L2 and third inductive element L3 respectively.

Similar to the examples provided in FIGS. 1 and 2, the current through the load discharges the series capacitor and the current provided by the inductive element charges the capacitor. In this example, the current through the first load LED1 discharges the first capacitor C1 and the current provided by the second inductive element L2 charges the first capacitor C1. The current through the second load LED2 discharges the second capacitor C2 and the current provided by the third inductive element L3 charges the second capacitor C2. Similar to the example of FIGS. 1 and 2, the voltage over the first capacitor C1 and the second capacitor C2 is negative, while the voltage required by the first load LED1 and the second load LED2 is larger than the bus voltage. With the control of the switching elements M1, M2 and M3, the voltage across the first capacitor C1 and the second capacitor C2 can also be controlled independently from each other. This allows the voltage required by the first load LED1 to be different from the voltage required by the second load LED2. The advantage in this situation is that a single bus voltage can be provided to multiple loads, even when the bus voltage does not match the voltage of the loads.

Preferably, the first switching element M1, the second switching element M2 and the third switching element M3 are controlled by a single controller. To provide a more stable bus voltage, this bus voltage can be buffered by a buffer capacitor C10.

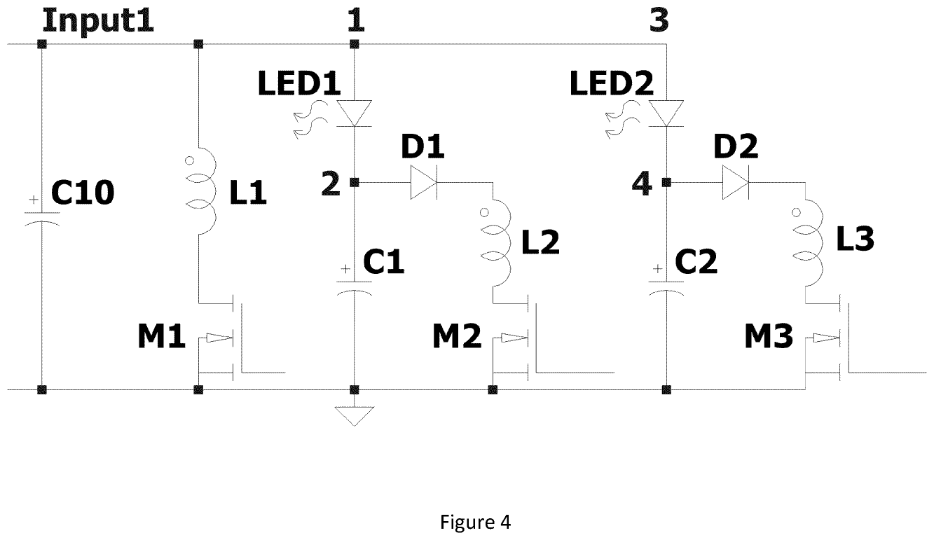

FIG. 4 shows another example of a powering system. This powering system is almost similar to the powering system of FIG. 3. The major difference is that the polarity of the first capacitor C1 and the second capacitor C2 are reversed. This means that the current provided by the second inductive element L2 and the third inductive element discharge the first capacitor C1 and the second capacitor C2 respectively. The current flowing through the first load LED1 and the current flowing through the second load LED2 charge the respective first capacitor C1 and the second capacitor C2. In this example, the capacitor voltages may be positive. The bus voltage may then be larger than the required load voltages.

As an example, for simplicity taking only the first load LED1 in consideration, the bus voltage may be 25 V and the required voltage for the first load LED1 may be 20 V.

The bus voltage is equal to the sum of the first load LED1 voltage and the first capacitor C1 voltage. The secondary power converter is then controlled to generate a voltage over the first capacitor of 5 V, resulting in V_{bus}=V_{load}+V_{c}, resulting in 25 V=20 V+5V.

To provide a more stable bus voltage, this bus voltage can be buffered by a buffer capacitor C10.

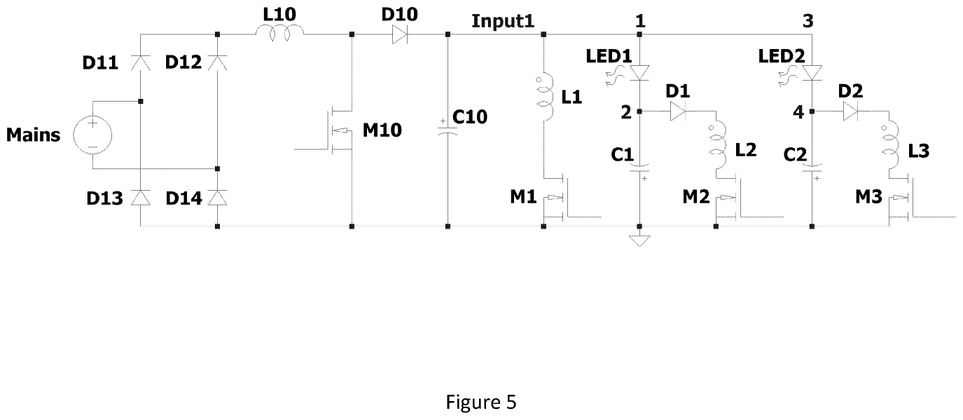

FIG. 5 shows another example of a powering system. The powering system has a first input Input1 that is arranged to receive a bus voltage. The powering system also has a ground node for providing a return path for the current provided via the input Input. This node is shown as the ground. In this example, it may also be referred to as the return node or first further node.

In this example, the bus voltage is provided by a mains power converter. The mains power converter may be configured to rectify a mains input voltage. A common mains voltage is 230 V at 50 Hz or 120 V at 60 Hz. This rectified mains voltage is converted by the mains power converter into the bus voltage. In this example, the mains power converter has an inductor L10, a switching element M10 and a unidirectional device D10 and is configured to operate as a boost converter. The mains power converter may be configured as any other type of switched mode power converter such as a boost converter, a buck converter, a buck-boost converter, a flyback converter or an LLC converter. The main purpose of the mains power converter is to convert an input voltage, in this case a mains voltage, into a regulated bus voltage at the input Input1.

A first inductive element L1 and a first switching element M1 are coupled in series between the second input Input2, which is in this example directly coupled to the first input Input1, and the return node. A first load LED1 and a first capacitor C1 are coupled in series between the first input Input1 and a first further node, which is in this example directly coupled to the return node. The first load LED1 may form part of the powering system. The powering system has therefore a first output 1 and a second output 2 to which the first load LED1 is coupled. In this example, the first output 1 is directly coupled to first input Input1. The second output 2 is in this example directly coupled to the first capacitor C1 and the anode of the first unidirectional device D1. The first unidirectional device D1, the second switching element M2 and the second inductive element L2 are coupled in series between the second output 2 and the first further node. In this example, the secondary power converter comprises the first inductive element L1, the first switching element M1, the first unidirectional device D1, the second switching element M2 and the second inductive element L2

A second load LED2 and a second capacitor C2 are coupled in series between the first input Input1 and a second further node, which is in this example directly coupled to the return node. The second load LED2 may form part of the powering system. The powering system has therefore a third output 3 and a fourth output 4 to which the second load LED2 is coupled. In this example, the third output 3 is directly coupled to first input Input1. The fourth output 4 is in this example directly coupled to the second capacitor C2 and the anode of the second unidirectional device D2. The second unidirectional device D2, a third switching element M3 and the third inductive element L3 are coupled in series between the fourth output 4 and the second further node. In this example, the tertiary power converter comprises the second unidirectional device D2, the third switching element M3 and the third inductive element L3. The controller may also be used to control the tertiary power converter. This means that the controller may for example be used to control the third switching element M3. The first inductive element L1, the second inductive element L2 and the third inductive element are inductively coupled such that the secondary power converter forms a flyback converter. A major difference with a regular flyback converter is that at the secondary side and the tertiary side i.e., at the side of the second inductive element L2 and the third inductive element L3, a switching element is placed to allow or prevent a current to flow to a corresponding first capacitor C1 or second capacitor C2. The current through the first inductive element L1 is reflected to the second inductive element L2 and the third inductive element L3. The second switching element M2 and the third switching element M3 can be controlled to independently control the currents flowing to the first capacitor C1 and the second capacitor C2 from the second inductive element L2 and third inductive element L3 respectively.

By coupling the series combination of the first inductive element L1 and the first switching element M1 between the first input and the return node, the control of the first switching element M1 can be simplified since a regulated bus voltage may be provided. When the bus voltage is lower than the voltage provided to the mains power converter, the components may have a lower voltage requirement, allowing smaller and/or cheaper components to be selected.

In this example, the mains power converter is combined with two loads. It should be understood that the mains power converter can be combined with any number of loads. A powering system for powering a single load, using for example the power stage according to FIG. 1 or 2, may also benefit from the mains power converter.

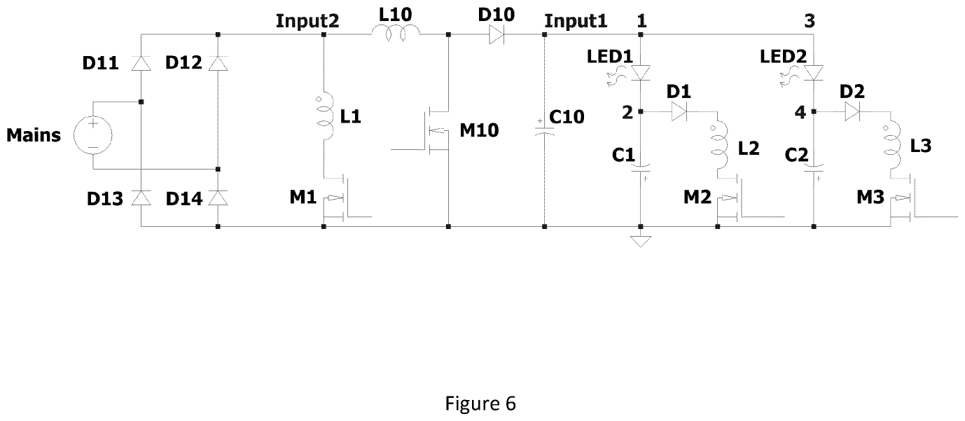

FIG. 6 shows an example of another powering system. The powering system is almost identical to the powering system of FIG. 5. The same configuration is used for controlling the voltage over the first capacitor C1 and the second capacitor C2. The powering system differs from the powering system of FIG. 5 in that the series combination of the first inductive element L1 and the first switching device M1 is placed at a second input Input2 and the return node. In the previous examples, the second input Input2 was directly coupled to the first input Input1. The second input Input2 is in this example coupled to the output of the rectifier D11, D12, D13 and D14. Therefore, the mains power converter does not need to provide a conversion of power required by the second power converter or the second power converter and the tertiary power converter. Instead, the power can be directly taken from the mains. This may result in a more power efficient power conversion for the powering system.

The term positive and negative voltage are based on a reference to ground i.e., the return node. This means that a voltage over a capacitor can be considered to be positive with respect to ground or negative with respect to ground.

In the examples provided, the charging and discharging of the capacitors can also be understood as providing a positive voltage over the capacitors or a negative voltage over the capacitors. For example, when the average current provided by the load is larger than the current provided by the inductive element, the capacitor will effectively be charged over time and the voltage over the capacitor will increase and be positive. When the average current provided by the load is smaller than the current provided by the inductive element, the capacitor will effectively be discharged over time and the voltage over the capacitor will decrease and may even turn negative.

In the examples provided, one load may require a voltage that is larger than the bus voltage while another load may require a voltage that is lower than the bus voltage. The polarity of the corresponding capacitors can be adjusted such that the larger and the lower voltage can be matched with the bus voltage.

In the examples provided, the switching elements may be any kind of semiconductor switches such as transistors and MOSFETs.

In the examples provided, the inductive elements can be a coil of a transformer. In a preferred example, a single transformer is used, such that all inductive elements for the secondary power converter or the secondary power converter and tertiary power converter form a single inductor and are therefore all inductively coupled to each other.

In the examples provided, the unidirectional devices can be for example a diode. A transistor can also be used, which is the controlled to allow conductivity in one direction and block conduction in the other direction.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A power stage for powering a first load, the first load being couplable between a first output and a second output, the power stage comprising:
the second output, a first further node, a second input and a return node;
a first input for receiving a bus voltage;
the first output coupled to the first input and arranged to be couplable to the first load;
a first capacitor coupled between the second output and the first further node and couplable in series with the first load;
a secondary power converter comprising:
a controller for controlling the secondary power converter;
a first inductive element and a first switching element coupled in series between the second input and the return node;
a second inductive element, inductively coupled to the first inductive element, and a first unidirectional device coupled in series between the second output and the first further node,
wherein the secondary power converter is arranged to provide a current to the first capacitor that is of a reverse polarity of a current provided to the first capacitor via the first load.

2. The power stage according to claim 1, wherein the second input is directly coupled to the first input.

3. The power stage according to claim 1, wherein the first further node is coupled to the return node.

4. The power stage according to claim 1, further comprising a linear current regulator in series between the first further node and the return node.

5. The power stage according to claim 1, wherein the current provided via the first load is arranged for discharging the first capacitor.

6. The power stage according to claim 1, wherein the current provided via the first load is arranged for charging the first capacitor.

7. The power stage according to claim 1, wherein the current provided via the second inductive element is arranged for charging the first capacitor.

8. The power stage according to claim 1, wherein the current provided via the second inductive element is arranged for discharging the first capacitor.

9. The power stage according to claim 1, wherein the secondary power converter is a flyback converter.

10. A powering system comprising:
a power stage according to claim 1;
a third output coupled to the first input and arranged to be couplable to a second load, the second load being couplable between the third output and a fourth output;
a second capacitor coupled between the fourth output and a second further node and couplable in series with the second load;
a tertiary power converter comprising:
a third inductive element, inductively coupled to the first inductive element, a third switching element and a second unidirectional device coupled in series between the fourth output and the second further node,
wherein the secondary power converter further comprises a second switching element in series with the first unidirectional device,
wherein the tertiary power converter is arranged to provide a current to the second capacitor that is of a reverse polarity of a current provided to the second capacitor via the second load.

11. The powering system of claim 10, further comprising the first load and the second load.

12. The powering system according to claim 10, wherein the first load and/or the second load is/are a lighting load.

13. The powering system according to claim 10, wherein the lighting load is a semiconductor lighting load.

14. The powering system according to claim 13, wherein a forward voltage of the first load is different from the forward voltage of the second load.

15. The powering system according to claim 10, further comprising a mains power converter adapted to convert a mains input voltage into the bus voltage.
